(19) United States
(12) Patent Application Publication
(10) Pub. No.: US 2008/0001966 A1
(43) Pub. Date: Jan. 3, 2008

(54) Straight line drawing method, straight line drawing program and straight line drawing apparatus

(75) Inventor: Jun Zhang, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/585,216

(22) Filed: Oct. 24, 2006

(30) Foreign Application Priority Data
Jun. 29, 2006 (JP) 2006-179584

(51) Int. Cl. G06T 11/20

(52) U.S. Cl. 345/623; 345/443

(57) ABSTRACT

The present invention relates to a straight line drawing method, a straight line drawing program and a straight line drawing apparatus, an object of the invention is to provide a straight line drawing apparatus, a straight line drawing method and a straight line drawing program, which can reduce fabrication costs and can improve processing performance. A midpoint between endpoints of a straight line is determined, when drawing the straight line, having the two end points located outside a drawing frame defined by frame defining lines wherein at least one of the two end points is located on the drawing frame side to all the frame defining lines. When the midpoint is located outside the drawing frame and at least one of the end point and the midpoint is located on the drawing frame side to any of the frame defining lines, the portion between the other end point and the midpoint is removed from the drawing target, and the end point and the midpoint are established as new two end points of a new drawing target straight line.

### BACKGROUND OF THE INVENTION

1. Field of the Invention

The present invention relates to a straight line drawing method, a straight line drawing program and a straight line drawing apparatus, which are used to draw a straight line in a drawing frame.

2. Description of the Related Art

For a graphics drawing apparatus which draws straight lines, there are a CRT (Cathode Ray Tube) and an LCD (Liquid Crystal Display), etc. FIG. 5 shows the relation of positions between a drawing frame (clip frame) and straight lines that are drawing targets in a graphics drawing apparatus. As shown in FIG. 5, an area surrounded by a rectangular drawing frame 101 is a drawing area in which straight lines are drawn. When a minimum value Xmin and a maximum value Xmax of an X-coordinate and a minimum value Ymin and a maximum value Ymax of a Y-coordinate in the drawing area are used, the drawing frame 101 includes four points described by individual coordinates (Xmin, Ymin), (Xmax, Ymin), (Xmin, Ymax) and (Xmax, Ymax) at four corners. Straight lines L11 to L14 are drawn in such a way that only portions thereof lying inside the drawing frame 101 are drawn and the portions lying outside the drawing frame 101 are not drawn. More specifically, the entire portion of the straight line L11, the portion between A′ and B of the straight line L13, and the portion between A′ and B′ of the straight line L14 are drawn because they lie in the drawing frame 101. On the other hand, the entire portion of the straight line L12, the portion between A and A′ of the straight line L13, and the portions between A and A′ and between B′ and B of the straight line L14 are not drawn because they lie outside the drawing frame 101.

FIG. 6 shows an exemplary straight line drawing method before. As shown in FIG. 6, a plane area is divided into nine areas by four straight lines a (X=Xmin), b (X=Xmax), c (Y=Ymin) and d (Y=Ymax) which define the drawing frame 101. Each area is associated with four bits of an area code by the following criteria. More specifically, the most significant bit MSB of an area code is 1 where X<Xmin, and 0 where X≧Xmin in the position coordinate. The second left bit is 1 where X>Xmax, and 0 where X≦Xmax. The third left bit is 1 where Y<Ymin, and 0 where Y≧Ymin. The least significant bit LSB is 1 where Y>Ymax, and 0 where Y≦Ymax. An area code (0000) represents that the area is inside the drawing frame 101, and area codes other than (0000) represent that the areas are outside the drawing frame 101.

When a straight line is drawn, first, the criteria above are used to determine area codes of a starting point A and a terminal point B of the straight line. When the area code of the starting point A is (0000) as in straight lines L21 and L22 shown in FIG. 6, a straight line is started to draw from the starting point A to the terminal point B. The straight line L21 has the area code (0000) for the terminal point B, and the terminal point B lies inside the drawing frame 101. Thus, the entire portion between A and B is drawn. The straight line L22 has an area code (0001) for the terminal point B, and the terminal point B lies outside the drawing frame 101 (+Y side). Thus, the line is drawn only to a point A′ at which the Y-coordinate is Ymax.

When the area code of the starting point A is not (0000) as in straight lines L23 to L25, a logical conjunction of the area codes of the end points A and B is determined. When the logical conjunction of the area codes of the end points A and B is not zero as in a straight line L23, the end points A and B are on the same side outside the drawing frame 101, and thus the straight line is not drawn. When the logical conjunction of the area codes of the end points A and B is zero as in straight lines L24 and L25, the coordinates of the intersection points of the straight lines L24 and L25 with straight lines a to d are determined.

For example, in the case of the straight line L24, the X-coordinate of the end point A is greater than Xmax, the coordinates (X_{A′}, Y_{A′}) of an intersection point A′ with the straight line b (X=Xmax) is determined by Equation (1) below, where, dydx is a slope value of the straight line L24.

X_{A′}=Xmax;

Y_{A′}=Y_{A}+(Xmax−X_{A})×(dydx) (1)

The portion between A and A′ of the straight line L24 is not drawn because it lies on the +X side outside the drawing frame 101. In addition, the area code of the intersection point A′ is (0001), and the logical conjunction with the area code (0001) of the terminal point B is not zero. Thus, the portion between A′ and B of the straight line L24 is not drawn as well.

In the case of the straight line L25, since the starting point A lies on the −X side and the +Y side outside the drawing frame 101, similarly to the description above, the intersection point A′ and an intersection point A″ are determined. When the intersection point A″ is determined, the area code of the intersection point A″ is (1000) and the intersection point A″ still lies in the area outside the drawing frame 101. Thus, it is necessary to further determine the intersection point A′. Since the area code of the intersection point A′ is (0000), the portion between A′ and B′ of the straight line L25 is drawn.

Patent Document 1: Japanese Patent No. 3066599 Patent Document 2: JP-A-2001-175243

However, by the straight line drawing method before, it is necessary to determine the intersection point A′ and the intersection point A″ in the case in which the end point A is in the area outside the drawing frame 101 and the logical conjunction of the area codes of the end points A and B is zero as in the straight lines L24 and L25. Since a division and a multiplication are required as in Equation (1) when the intersection point is determined, an arithmetic circuit needs to have an adder-subtracter as well as a divider and a multiplier. A large scale and complex divider and multiplier increase costs of the straight line drawing apparatus, and are the bottleneck of circuit processing performance. Therefore, the straight line drawing apparatus before has a problem that fabrication costs are increased and processing performance is decreased.

### SUMMARY OF THE INVENTION

An object of the invention is to provide a straight line drawing apparatus, a straight line drawing method and a straight line drawing program, which can reduce fabrication costs and can improve processing performance.

The object can be achieved by a straight line drawing method including: determining a third point which is on a drawing target straight line inside a drawing frame, when the drawing target straight line is drawn which has two end points as first and second points that are located outside the drawing frame defined by a plurality of frame defining lines, and in which at least one of the first and the second points is located on the drawing frame side with respect to any of the plurality of the frame defining lines; and drawing the drawing target straight line inside the frame, when the third point exists.

In addition, the object can be achieved by a straight line drawing program allowing a computer to execute the procedures of: determining a third point which is on a drawing target straight line inside a drawing frame, when the drawing target straight line is drawn which has two end points as first and second points that are located outside the drawing frame defined by a plurality of frame defining lines, and in which at least one of the first and the second points is located on the drawing frame side with respect to any of the plurality of the frame defining lines; and drawing the drawing target straight line inside the frame, when the third point exists.

Moreover, the object can be achieved by a straight line drawing apparatus including: an arithmetic circuit which determines a third point which is on a drawing target straight line inside a drawing frame, when the drawing target straight line is drawn which has two end points as first and second points that are located outside the drawing frame defined by a plurality of frame defining lines, and in which at least one of the first and the second points is located on the drawing frame side with respect to any of the plurality of the frame defining lines; and a straight line drawing circuit which draws the drawing target straight line inside the frame, when the third point exists.

According to the invention, a straight line drawing apparatus, a straight line drawing method and a straight line drawing program can be implemented, which can reduce fabrication costs and can improve processing performance.

### BRIEF DESCRIPTION OF THE DRAWINGS

The teachings of the invention can be readily understood by considering the following detailed description in conjunction with the accompanying drawings, in which:

FIG. 1 shows diagram depicting an exemplary straight line drawing method according to an embodiment of the invention;

FIG. 2 shows a block diagram depicting the basic configuration of a straight line drawing apparatus according to an embodiment of the invention;

FIG. 3 shows a block diagram depicting an exemplary configuration of a midpoint arithmetic circuit;

FIG. 4 shows a diagram depicting the transition of the states of a control unit of the straight line drawing apparatus according to an embodiment of the invention;

FIG. 5 shows a diagram depicting the relation between a drawing frame and straight lines to be drawing targets; and

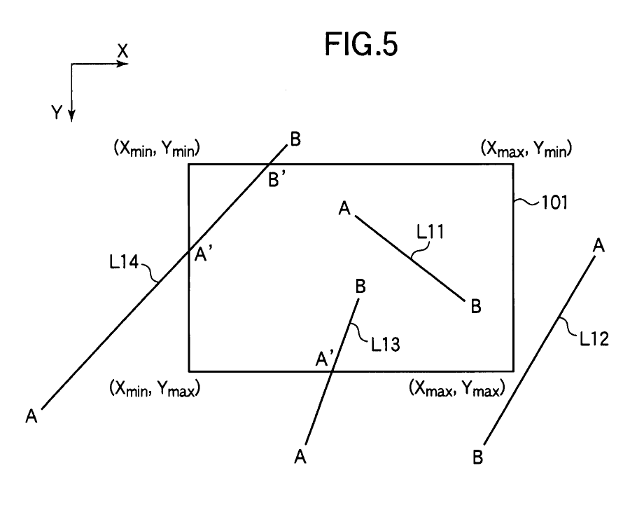

FIG. 6 shows a diagram depicting an exemplary conventional straight line drawing method.

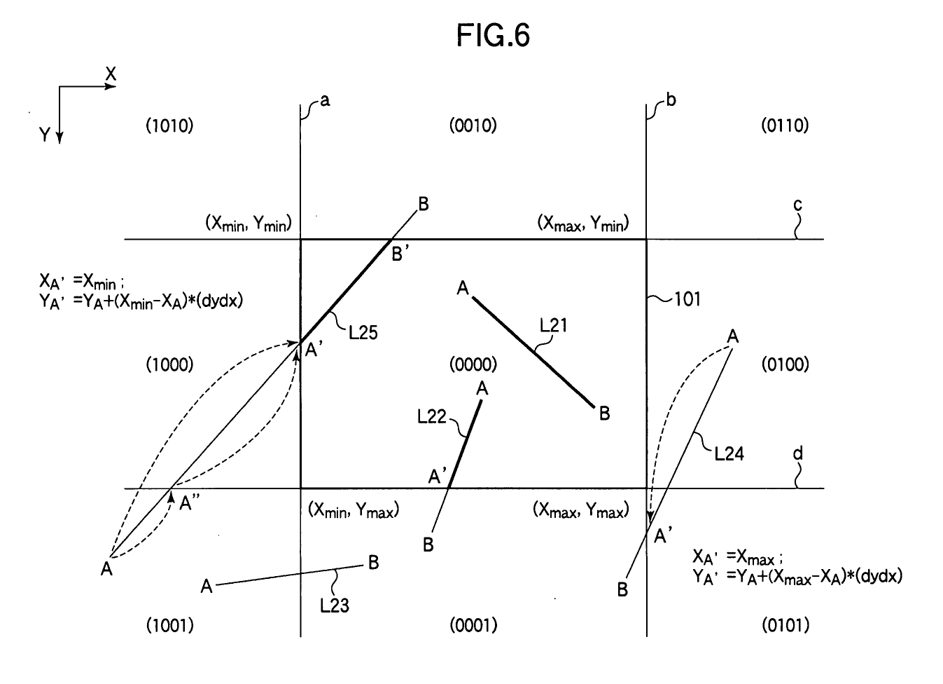

### DETAILED DESCRIPTION OF THE INVENTION

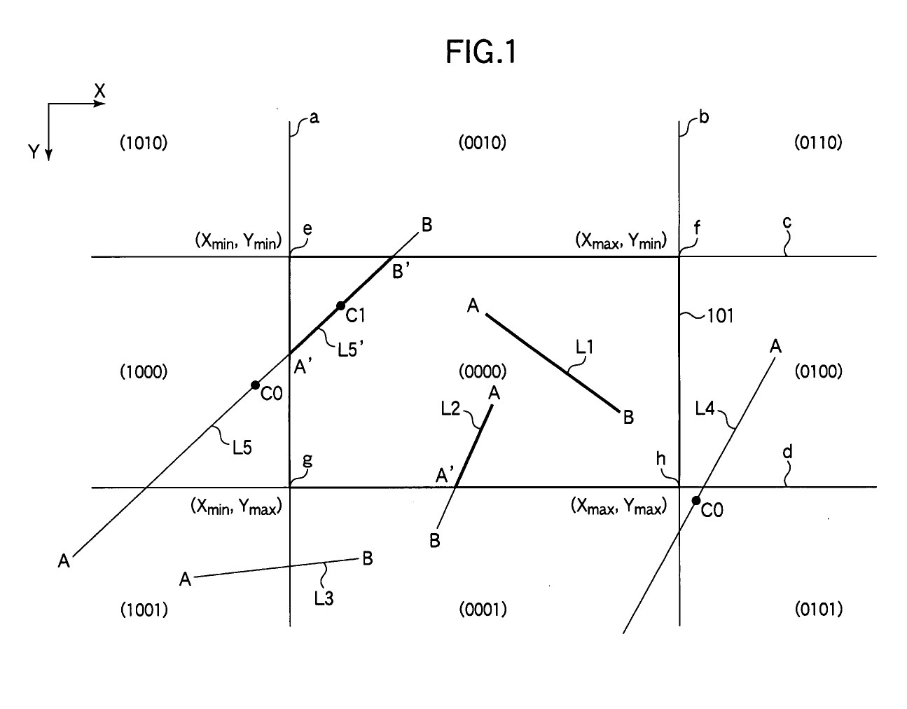

A straight line drawing method, a straight line drawing program and a straight line drawing apparatus according to an embodiment of the invention will be described with reference to FIGS. 1 to 4. FIG. 1 shows an exemplary straight line drawing method according to the embodiment. As shown in FIG. 1, an area surrounded by a rectangular drawing frame 101 is a drawing area in which straight lines are drawn. When a minimum value Xmin and a maximum value Xmax of an X-coordinate and a minimum value Ymin and a maximum value Ymax of a Y-coordinate of the drawing area are used, the drawing frame 101 includes four points, a point e (Xmin, Ymin), a point f (Xmax, Ymin), a point g (Xmin, Ymax) and a point h (Xmax, Ymax) at four corners.

A plane area is divided into nine areas by four frame defining lines a (X=xmin), b (X=Xmax), c (Y=Ymin) and d (Y=Ymax) which define the drawing frame 101. Each area is associated with four bits of an area code by the following criteria. More specifically, the most significant bit MSB of an area code is 1 where X<Xmin, and 0 where X≧Xmin in the position coordinates. The second left bit is 1 where X>Xmax, and 0 where X≦Xmax. The third left bit is 1 where Y<Ymin, and 0 where Y≧Ymin. The least significant bit LSB is 1 where Y>Ymax, and 0 where Y≦Ymax. An area code (0000) represents that the area is inside (including on the frame) the drawing frame 101, and area codes other than (0000) represent that the areas are outside the drawing frame 101.

When straight lines L1 to L5 which are drawing targets are drawn, first, the criteria above are used to determine area codes of an end point (a starting point) A and an end point (a terminal point) B of each of the straight lines. In the example shown in FIG. 1, both of the area codes of the starting point A and the terminal point B of the straight line L1 are (0000). The area code of the starting point A of the straight line L2 is (0000), and the area code of the terminal point B is (0001). The area code of the starting point A of the straight line L3 is (1001), and the area code of the terminal point B is (0001). The area code of the starting point A of the straight line L4 is (0100), and the area code of the terminal point B is (0001). The area code of the starting point A of the straight line L5 is (1001), and the area code of the terminal point B is (0010).

When the area code of the starting point A is (0000) as in the straight lines L1 and L2, drawing a straight line is started from the starting point A to the terminal point B. For the straight line L1, the area code of the terminal point B is also (0000), and the terminal point B is located inside the drawing frame 101. Thus, the entire portion between the starting point A and the terminal point B is drawn. For the straight line L2, the area code of the terminal point B is (0001), and the terminal point B is located on the +Y side outside the drawing frame 101. Thus, the portion to a point A′ is drawn at which the Y-coordinate is Ymax.

When both of the area codes of the end points A and B are not (0000) as in the straight lines L3 to L5, the logical conjunction of the area codes of the end points A and B is determined. The logical conjunction of the area codes of the end points A and B for a drawing target straight line is determined to know the relation of positions between the end points A and B of the drawing target straight line and individual frame defining lines a to d. When the logical conjunction of the area codes of the end points A and B is zero, at least one of the end points A and B is located on the drawing frame 101 side with respect to any of the frame defining lines a to d. Therefore, it is likely that the drawing target straight line partially passes through inside the drawing frame 101. On the other hand, the logical conjunction of the area codes of the end points A and B is not zero, both of the end points A and B are located on the opposite side of the drawing frame 101 with respect to at least any one of the frame defining lines a to d. Therefore, it is unlikely that the drawing target straight line passes through inside the drawing frame 101, and there is no point on the drawing target straight line inside the drawing frame 101.

The straight line L3 has the area codes of the end points A and B which are not (0000), and has the logical conjunction of the area codes of the end points A and B which is not zero. Thus, there is no possibility that the straight line L3 passes through inside the drawing frame 101, and drawing the straight line L3 is finished.

The straight lines L4 and L5 have the area codes of the end points A and B which are not (0000), and have the logical conjunction of the area codes of the end points A and B which is zero. Therefore, it is likely that both of the straight lines L4 and L5 partially pass through inside the drawing frame 101. As described below, the embodiment has a main feature in that a straight line can be easily drawn as in the straight lines L4 and L5 having the area codes of the end points A and B which are not (0000) and having the logical conjunction of the area codes of the end points A and B which is zero.

In the embodiment, for the straight line L4, a midpoint C0 between the end points A and B is determined by Equation (2) below. An X-coordinate X_{C} of the midpoint C0 is determined by adding an X-coordinate X_{A} of the end point A to an X-coordinate X_{B} of the end point B and dividing the sum by two. A Y-coordinate Y_{C} of the midpoint C0 is determined by adding a Y-coordinate Y_{A} of the end point A to a Y-coordinate Y_{B} of the end point B and dividing the sum by two. Here, a numeric value X expressed by binary numbers results in X/2 by right shift operation that truncates one bit of the least significant. Thus, with the adder, the operation of Equation (2) can be done. In the embodiment, the intersection point of the drawing target straight line with the frame defining line is not determined, whereby a multiplier and a divider are not required, which are necessary conventionally.

X_{C}=(X_{A}+X_{B})/2

Y_{C}=(Y_{A}+Y_{B})/2 (2)

The area code of the midpoint C0 of the straight line L4 is (0101), and the logical conjunction with the area code of the end point A and the logical conjunction with the area code of the end point B are not zero. This reveals that the portions between the end point A and the midpoint C0 and between the end point B and the midpoint C0 of the straight line L4 are in the area outside the drawing frame 101. Therefore, drawing the straight line L4 is finished.

Similarly, for the straight line L5, the midpoint C0 between the end points A and B is determined by Equation (2). The area code of the midpoint C0 of the straight line L5 is (1000), and the midpoint C0 is in the area outside the drawing frame 101. In addition, the logical conjunction of the area code of the midpoint C0 of the straight line L5 and the area code of the end point A is not zero, and both of the end point A and the midpoint C0 are located on the opposite side of the drawing frame 101 with respect to the frame defining line a. This reveals that the portion between the end point A and the midpoint C0 of the straight line L5 is in the area outside the drawing frame 101.

On the other hand, since the logical conjunction of the area code of the midpoint C0 and the area code of the end point B of the straight line L5 is zero, at least one of the midpoint C0 and the end point B is located on the drawing frame 101 side with respect to any of the frame defining lines a to d. Therefore, the portion between the end point A and the midpoint C0 of the straight line L5 is removed from the drawing target. Moreover, the coordinates of the midpoint C0 are substituted into the coordinates of the end point A to establish the midpoint C0 as a new end point, and the end point C0 and the end point B are established as new end points of a drawing target straight line L5′. In addition, for the straight line having the midpoint outside the drawing frame 101, any of the logical conjunctions of the area code of the midpoint and the area codes of the two end points do not result in zero. Therefore, when it is known that the logical conjunction of the area code of the midpoint and the area code of one of the end points is zero, the logical conjunction of the area code of the midpoint and the area code of the other end point is not necessarily determined.

Similarly, for the new straight line L5′, a new midpoint C1 between the end points C0 and B is determined by Equation (2). The area code of the midpoint C1 of the straight line L5′ is (0000), and the midpoint C1 is located inside the drawing frame 101. Therefore, drawing a straight line is started from the midpoint C1 to the end point C0. Since the end point C0 is located on the −X side outside the drawing frame 101, the straight line is drawn to a point A′ at which the X-coordinate is Xmin. In addition, drawing a straight line is started from the midpoint C1 to the end point B. Since the end point B is located on the −Y side outside the drawing frame 101, a straight line is drawn to the point B′ at which the Y-coordinate is Ymin.

As described above, for the straight line such as the straight lines L4 and L5 having the area codes of the end points A and B which are not (0000) and having the logical conjunction of the area codes of the end points A and B which is zero, new midpoints C0, C1, and so on are continuously determined until it is revealed that the area code of the midpoint is (0000), or, both of the logical conjunctions of the area code of the midpoint and the area codes of the two end points are not zero. Suppose that the distance between the end points A and B of a straight line is AB, the midpoint is to be determined for the maximum log₂ (A B) number of times.

Hereinafter, an exemplary algorithm in C is shown, which allows a computer to execute the individual procedures of the straight line drawing method according to the embodiment.

typedef struct {
// An X-coordinate (an integer is also possible);
float X;
// A Y-coordinate (an integer is also possible);
float Y;
} PCoord;
// A function which determines an area code;
int RegionCoding( );
// A function which draws a straight line in a drawing frame;
void DrawLine( );
// Determine the coordinates of a midpoint C;
PCoord MiddlePoint(PCoord A; PCoord B) {PointCoord C;
C.X = (A.X + B.X)/2;
C.Y = (A.Y + B.Y)/2;
return C;
}
// A function which determines a logical junction;
int LogicOR(int A; int B) {
int C:
C = A|B;
Return C;
}
void main( ) {
PCoord A, B, C;
PCoord LeftTop, RightBottom;
int CodeA, CodeB, CodeC;
// Determine the area codes of end points A and B;
CodeA = RegionCoding(A);
CodeB = RegionCoding(B);
if (CodeA == O){
// Draw a straight line from the end point A to the end point
B, if the end point A is inside the drawing frame;
DrawLine(A, B);
} else if (CodeB == 0) {
// Draw a straight line from the end point B to the end point
A, if the end point B is inside the drawing frame;
DrawLine(B, A);
} else if (LogicOR(A,B) ! = 0) {
// End drawing if the entire straight line is outside the drawing
frame;
return 0;
} else {
while (1) {
// Determine coordinates and an area code of the midpoint C;
C = MiddlePoint(A, B);
CodeC = RegionCoding(C);
if (CodeC == 0) {
// Draw a straight line from C to A and C to B, if the midpoint
C is inside the drawing frame, and end drawing;
DrawLine(C, A);
DrawLine(C, B);
return 1;
} else if (LogicOR (C, A) == 0) {
// Replace the end point B at the midpoint C, and determine
a new midpoint C, if the portion between C and B of the straight
line is outside the drawing frame;
B = C;
} else if (LogicOR(C, B) == 0) {
// Replace the end point A at the midpoint C, and determine
a new midpoint C, if the portion between C and A of the straight
line is outside the drawing frame;
A = C;
} else {
// End, if both of the portions between C and A and between
C and B of the straight line are outside the drawing frame;
return 0:
}
}
}
}

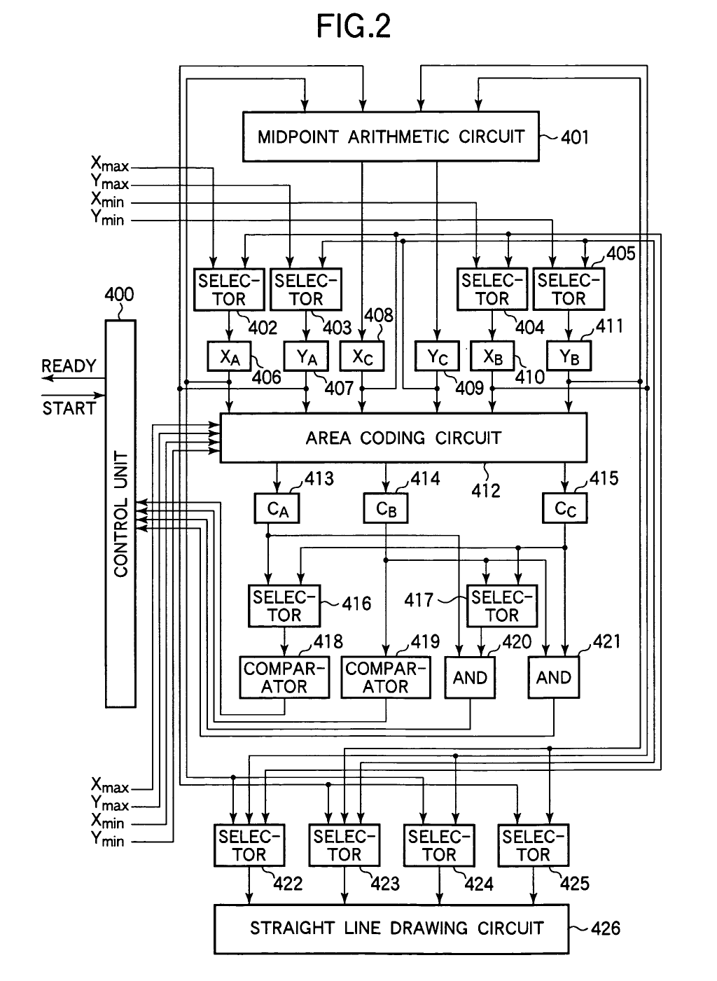

Next, an exemplary configuration of a straight line drawing apparatus will be described, which implements the straight line drawing method according to the embodiment in hardware. FIG. 2 shows a block diagram depicting the basic configuration of a straight line drawing apparatus according to the embodiment. In FIG. 2, a Ready signal outputted from a control unit 400 represents that a new drawing target straight line can be drawn. Before the straight line is drawn, the maximum value Xmax and the minimum value Xmin of the X-coordinate and the maximum value Ymax and the minimum value Ymin of the Y-coordinate of the drawing area are written in resisters disposed in an area coding circuit 412. The coordinates (X_{A}, Y_{A}) of the end point A and the coordinates (X_{B}, Y_{B}) of the end point B of the drawing target straight line are each selected by selectors 402, 403, 404 and 405. The X-coordinate X_{A} of the end point A is written in a resister X_{A}406, and the Y-coordinate Y_{A} of the end point A is written in a resister Y_{A}407. The X-coordinate X_{B} of the end point B is written in a resister X_{B}410, the Y-coordinate Y_{B} of the end point B is written in a resister Y_{B}411. When a Start signal inputted to the control unit 400 is turned to High level, the control unit 400 controls starting the drawing of a drawing target straight line from the next cycle.

The coordinates (X_{A}, Y_{A}) of the end point A and the coordinates (X_{B}, Y_{B}) of the end point B outputted from the resister X_{A}406, the resister Y_{A}407, the resister X_{B}410 and the resister Y_{B}411 are inputted to the area coding circuit 412. The area coding circuit 412 computes area codes C_{A} and C_{B} of the end points A and B from each of the coordinates of the end points A and B. The area code C_{A} of the end point A is written in an area code resister C_{A}413, and the area code C_{B} of the end point B is written in an area code resister C_{B}414. In addition, the coordinates (X_{A}, Y_{A}) of the end point A and the coordinates (X_{B}, Y_{B}) of the end point B outputted from the resister X_{A}406, the resister Y_{A}407, the resister X_{B}410 and the resister Y_{B}411 are inputted to a midpoint arithmetic circuit 401 as well. The midpoint arithmetic circuit 401 computes the coordinates (X_{C}, Y_{C}) of the midpoint C from each of the coordinates of the end points A and B. The X-coordinate X_{C} of the midpoint C is written in a resister X_{C}408, and the Y-coordinate Y_{C} of the midpoint C is written in a resister Y_{C}409.

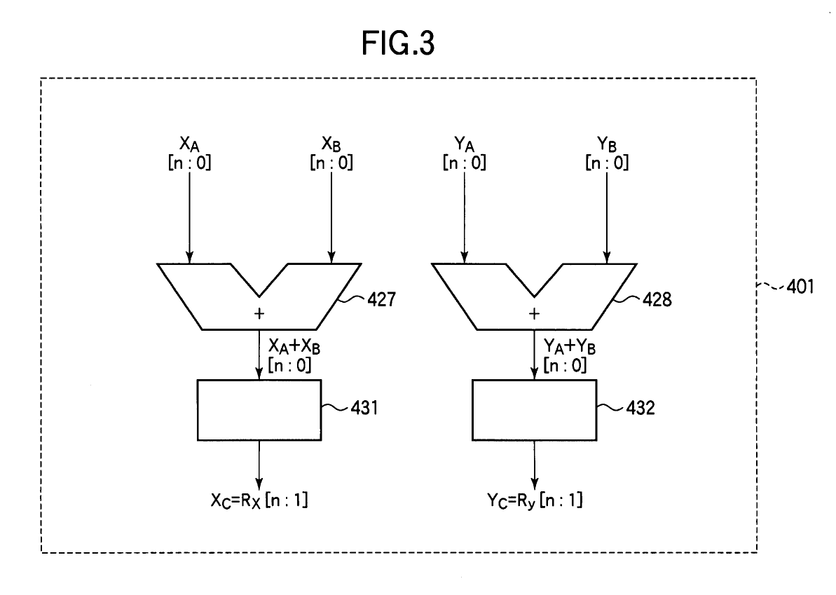

FIG. 3 shows a block diagram depicting an exemplary configuration of the midpoint arithmetic circuit 401. As shown in FIG. 3, the midpoint arithmetic circuit 401 has an adder 427 and a shift computing unit 431 which is disposed subsequent to the adder 427. The adder 427 receives the X-coordinate X_{A} of the end point A and the X-coordinate X_{B} of the end point B, and outputs the sum (X_{A}+X_{B}) to the shift computing unit 431. X_{A}, X_{B} and (X_{A}+X_{B}) are all (n+1) bits (for example, 32 bits) of data. The shift computing unit 431 truncates one bit of the least significant of the inputted sum (X_{A}+X_{B}), and outputs X_{C}, which is the X-coordinate of the midpoint C between the end points A and B. X_{C} is n bits of data, almost equal to (X_{A}+X_{B})/2.

In addition, the midpoint arithmetic circuit 401 has an adder 428 and a shift computing unit 432 which is disposed subsequent to the adder 428. The adder 428 receives the Y-coordinate Y_{A} of the end point A and the Y-coordinate Y_{B} of the endpoint B, and outputs the sum (Y_{A}+Y_{B}) to the shift computing unit 432. Y_{A}, Y_{B} and (Y_{A}+Y_{B}) are all (n+1) bits (for example, 32 bits) of data. The shift computing unit 432 truncates one bit of the least significant of the sum (Y_{A}+Y_{B}), and outputs Y_{C}, which is the Y-coordinate of the midpoint C between the end points A and B. Y_{C} is n bits of data, almost equal to (Y_{A}+Y_{B})/2.

Returning to FIG. 2, the area code C_{A} of the end point A outputted from the area code resister C_{A}413 is selected by the selector 416, and is compared with the area code (0000) inside the drawing frame by the comparator 418. The area code C_{B} of the end point B outputted from the area code resister C_{B}414 is compared with the area code (0000) inside the drawing frame by the comparator 419. In addition, the area code C_{B} of the end point B outputted from the area code resister C_{B}414 is selected by the selector 417, and inputted to an AND circuit 420. The AND circuit 420 determines the logical conjunction of the area code C_{B} of the end point B and the area code C_{A} of the end point A outputted from the area code resister C_{A}413, and outputs the determined logical conjunction to the control unit 400. In addition, the X-coordinate X_{C} of the midpoint C outputted from the resister X_{C}408 and the Y-coordinate Y_{C} of the midpoint C outputted from the resister Y_{C}409 are inputted to the area coding circuit 412. The area coding circuit 412 computes the area code C_{C} of the midpoint C from the coordinates of the midpoint C. The area code C_{C} of the midpoint C is written in a midpoint area code resister C_{C}15.

To the control unit 400, a signal representing whether the area code C_{A} of the end point A is (0000) is inputted from the comparator 418, and a signal representing whether the area code C_{B} of the endpoint B is (0000) is inputted from the comparator 419. When the area code C_{A} of the end point A is (0000), the end point A is inside drawing frame. Thus, the control unit 400 allows the selectors 422 and 423 to select the X-coordinate X_{A} of the end point A outputted from the resister X_{A}406 and the Y-coordinate Y_{A} of the end point A outputted from the resister Y_{A}407, respectively, and to output them to the straight line drawing circuit 426. In addition, the control unit 400 allows the selectors 424 and 425 to select the X-coordinate X_{B} of the endpoint B outputted from the resister X_{B}410 and the Y-coordinate Y_{B} of the end point B outputted from the resister Y_{B}411, respectively, and to output them to the straight line drawing circuit 426. From the next cycle, the straight line drawing circuit 426 draws a straight line from the end point A to the end point B.

When the area code C_{A} of the end point A is not (0000) and the area code C_{B} of the end point B is (0000), the end point A is outside the drawing frame and the end point B is inside the drawing frame. Therefore, the control unit 400 allows the selectors 422 and 423 to select the X-coordinate X_{B} of the end point B outputted from the resister X_{B}410 and the Y-coordinate Y_{B} of the end point B outputted from the resister Y_{B}411, and to output them to the straight line drawing circuit 426. In addition, the control unit 400 allows the selectors 424 and 425 to select the X-coordinate X_{A} of the end point A outputted from the resister X_{A}406 and the Y-coordinate Y_{A} of the end point A outputted from the resister Y_{A}407, and to output them to the straight line drawing circuit 426. From the next cycle, the straight line drawing circuit 426 draws a straight line from the end point B to the end point A.

When both of the area codes C_{A} and C_{B} of the end points A and B are not (0000) and the logical conjunction of the area codes C_{A} and C_{B} of the end points A and B is not zero, both of the end points A and B are on the same side outside the drawing frame. Thus, a straight line is not drawn, and the process ends.

When both of the area codes C_{A} and C_{B} of the end points A and B are not (0000) and the logical conjunction of the area codes C_{A} and C_{B} of the end points A and B is zero, the midpoint C is used to make a drawing decision from the next cycle. The area code C_{C} of the midpoint C outputted from the area code resister C_{C}415 is selected by the selector 416, and is compared with the area code (0000) inside the drawing frame by the comparator 418. In addition, the area code C_{C} of the midpoint C outputted from the area code resister C_{C}415 is selected by the selector 417, and inputted to the AND circuit 420. The AND circuit 420 determines the logical conjunction of the inputted area code C_{C} and the area code C_{A} of the end point A outputted from the area code resister C_{A}413, and outputs the determined logical conjunction to the control unit 400. An AND circuit 421 determines the logical conjunction of the area code C_{C} of the midpoint C outputted from the area code resister C_{C}415 and the area code C_{B} of the end point B outputted from the area code resister C_{B}414, and outputs it to the control unit 400.

To the control unit 400, a signal representing whether the area code C_{C} of the midpoint C is (0000) is inputted from the comparator 418. When the area code C_{C} of the midpoint C is (0000), the midpoint C is inside the drawing frame. Thus, the control unit 400 allows the selectors 422 and 423 to select the X-coordinate X_{C} of the midpoint C outputted from the resister X_{C}408 and the Y-coordinate Y_{C} of the midpoint C outputted from the resister Y_{C}409, and to output them to the straight line drawing circuit 426. In addition, the control unit 400 allows the selectors 424 and 425 to select the X-coordinate X_{A} of the endpoint A outputted from the resister X_{A}406 and the Y-coordinate Y_{A} of the end point A outputted from the resister Y_{A}407, and to output them to the straight line drawing circuit 426. From the next cycle, the straight line drawing circuit 426 draws a straight line from the midpoint C to the end point A. When drawing the straight line is completed, the control unit 400 allows the selectors 424 and 425 to select the X-coordinate X_{B} of the end point B outputted from the resister X_{B}410 and the Y-coordinate Y_{B} of the end point B outputted from the resister Y_{B}411, and to output them to the straight line drawing circuit 426. From the next cycle, the straight line drawing circuit 426 draws a straight line from the midpoint C to the end point B. When drawing the straight line is completed, the process ends.

When the area code C_{C} of the midpoint C is not (0000) and the logical conjunction of the area code C_{C} of the midpoint C and the area code C_{A} of the end point A and the logical conjunction of the area code C_{C} of the midpoint C and the area code B_{C} of the end point B are not zero, the portions between the midpoint C and the end point A and between the midpoint C and the end point B of the straight line are in the area outside the drawing frame. Thus, a straight line is not drawn, and the process ends.

When the area code C_{C} of the midpoint C is not (0000) and the logical conjunction of the area code C_{C} of the midpoint C and the area code C_{A} of the end point A are zero, the control unit 400 allows the selectors 404 and 405 to select the X-coordinate X_{C} of the midpoint C outputted from the resister X_{C}408 and the Y-coordinate Y_{C} of the midpoint C outputted from the resister Y_{C}409. The X-coordinate X_{C} of the midpoint C is written in the resister X_{B}410, replacing the X-coordinate X_{B} of the end point B, and the Y-coordinate Y_{C} of the midpoint C is written in the resister Y_{B}411, replacing the Y-coordinate Y_{B} of the end point B. From the next cycle, the coordinates (X_{A}, Y_{A}) and (X_{B}, Y_{B}) of new end points are used to determine a new midpoint C. After that, similarly to the description above, the new midpoint C is used to continue making a drawing decision until it is revealed that the area code C_{C} of the midpoint C is (0000), or, any of the logical conjunctions of the area code C_{C} of the midpoint C and the area codes C_{A} and C_{B} of the end points A and B are not zero.

When the area code C_{C} of the midpoint C is not (0000) and the logical conjunction of the area code C_{C} of the midpoint C and the area code C_{B} of the end point B is zero, the control unit 400 allows the selectors 402 and 403 to select the X-coordinate X_{C} of the midpoint C outputted from the resister X_{C}408 and the Y-coordinate Y_{C} of the midpoint C outputted from the resister Y_{C}409, respectively. The X-coordinate X_{C} of the midpoint C is written in the resister X_{A}406, replacing the X-coordinate X_{A} of the end point A, and the Y-coordinate Y_{C} of the midpoint C is written in the resister Y_{A}407, replacing the Y-coordinate Y_{A} of the end point A. From the next cycle, the coordinates (X_{A}, Y_{A}) and (X_{B}, Y_{B}) of the new end points are used to determine a new midpoint C. After that, similarly to the description above, the new midpoint C is used to continue making a drawing decision until it is revealed that the area code C_{C} of the midpoint C is (0000), or, any of the logical conjunctions of the area code C_{C} of the midpoint C and the area codes C_{A} and C_{B} of the end points A and B are not zero.

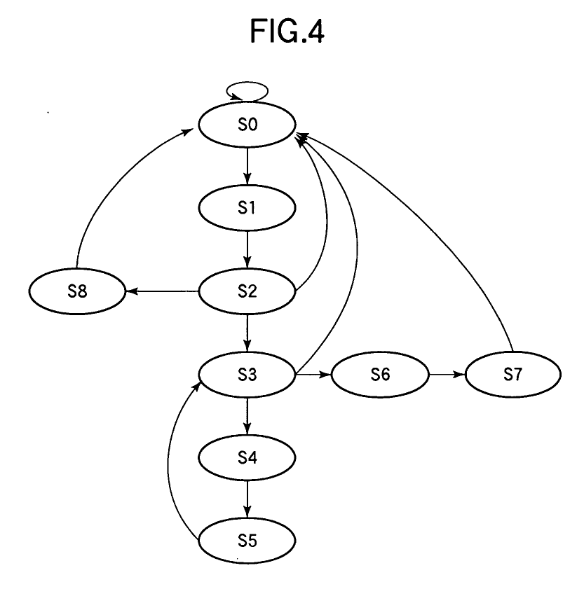

FIG. 4 shows a diagram depicting the transition of the states of the control unit 400 and the other devices of the straight line drawing apparatus. As shown in FIG. 4, the conditions of the control unit 400 have nine sates, States S0 to S8. The period of States S0 to S5 is one cycle each, and the period of States S6 to S8 is generally a few cycles.

In State S0, the straight line drawing apparatus is idle. In State S0, the maximum value Xmax and the minimum value Xmin of the X-coordinate and the maximum value Ymax and the minimum value Ymin of the Y-coordinate configuring the drawing frame are written in the resisters in the area coding circuit 412. In addition, the coordinates (X_{A}, Y_{A}) of the end point A and the coordinates (X_{B}, Y_{B}) of the end point B of the drawing target straight line are written in the resister X_{A}406, the resister Y_{A}407, the resister X_{B}410 and the resister Y_{B}411, respectively. When the Start signal inputted to the control unit 400 is turned to High level, the state goes to State S1 at the next cycle to start the straight line drawing process. When the Start signal inputted to the control unit 400 is Low level, the next cycle is also State S0.

In State S1, the coordinates (X_{A}, Y_{A}) of the end point A and the coordinates (X_{B}, Y_{B}) of the end point B of the drawing target straight line are used to determine the area code C_{A} of the end point A, the area code C_{B} of the end point B and the coordinates (X_{C}, Y_{C}) of the midpoint C. The next cycle goes to State S2.

In State S2, the area codes C_{A} and C_{B} of the end points A and B are used to make a drawing decision, and the coordinates (X_{C}, Y_{C}) of the midpoint C are used to determine the area code C_{C} of the midpoint C. When the area code C_{A} of the end point A is (0000), the state goes to State S8 at the next cycle, and a straight line is drawn from the end point A to the end point B. When the area code C_{A} of the end point A is not (0000) and the area code C_{B} of the end point B is (0000), the state goes to State S8 at the next cycle, and a straight line is drawn from the end point B to the end point A. When both of the area codes C_{A} and C_{B} of the end points A and B are not (0000), and the logical conjunction of the area codes C_{A} and C_{B} is not zero, a straight line is not drawn, and the drawing process is finished. The next cycle goes to State S0. When both of the area codes C_{A} and C_{B} of the end points A and B are not (0000) and the logical conjunction of the area codes C_{A} and C_{B} is zero, the state goes to State S3 at the next cycle. The area code C_{C} of the midpoint C is used to make a drawing decision.

In State S3, when the area code C_{C} of the midpoint C is (0000), the state goes to State S6 at the next cycle, and a straight line is drawn from the midpoint C to the end point A. When the area code C_{C} of the midpoint C is not (0000) and any of the logical conjunctions of the area code C_{C} of the midpoint C and the area codes C_{A} and C_{B} of the end points A and B are not zero, drawing the straight line is finished, and the next cycle goes to State S0. When the area code C_{C} of the midpoint C is not (0000) and the logical conjunction of the area code C_{C} of the midpoint C and the area code C_{A} of the end point A is zero, the coordinates of the midpoint C are substituted into the coordinates of the end point B. When the area code C_{C} of the midpoint C is not (0000) and the logical conjunction of the area code C_{C} of the midpoint C and the area code C_{B} of the end point B is zero, the coordinates of the midpoint C is substituted into the coordinates of the end point A. The state goes to State S4 at the next cycle, and new end points A and B are used to determine a new midpoint C.

In State S4, the new end points A and B are used to determine the new midpoint C. The state goes to State S5 at the next cycle.

In State S5, the area code C_{C} of the new midpoint C is determined. The state returns to State S3 at the next cycle, a drawing decision is made to the new midpoint C.

In State S6, a straight line is drawn from the midpoint C to the end point A. When the straight line drawing is completed, the state goes to State S7 at the next cycle.

In State S7, a straight line is drawn from the midpoint C to the end point B. When drawing the straight line is completed, the state goes to State S0 at the next cycle.

In State S8, a straight line is drawn from the end point A to the end point B (or from the end point B to the end point A). When drawing the straight line is completed, the state goes to State S0 at the next cycle.

As described above, in the embodiment, when both of the end points A and B of the drawing target straight line are in the area outside the drawing frame and the logical conjunction of the area codes C_{A} and C_{B} of both of the end points A and B is zero, the point on the drawing target straight line located inside the drawing frame (area code (0000)) is determined, not determining the intersection point of the drawing target straight line with the frame defining line (the drawing frame). The point located inside the drawing frame can be determined by repeatedly determining the midpoint between the two end points with the use of an adder. Therefore, according to the embodiment, the circuit configuration of the arithmetic circuit can be simplified, and fabrication costs of the straight line drawing apparatus can be reduced. In addition, the arithmetic circuit does not need to have a divider and a multiplier, and thus circuit processing performance can be improved.

What is claimed is:

1. A straight line drawing method comprising:
determining a third point which is on a drawing target straight line inside a drawing frame, when the drawing target straight line is drawn which has two end points as first and second points that are located outside the drawing frame defined by a plurality of frame defining lines, and in which at least one of the first and the second points is located on the drawing frame side with respect to any of the plurality of the frame defining lines; and
drawing the drawing target straight line inside the frame, when the third point exists.

2. A straight line drawing method according to claim 1, wherein the drawing target straight lines are drawn from the third point to the first and to the second point.

3. A straight line drawing method according to claim 1, wherein when the third point does not exist, drawing the drawing target straight line is finished.

4. A straight line drawing method according to claim 1,
wherein a midpoint between the first and the second points on the drawing target straight line is determined; and
the midpoint is established as the third point when the midpoint is located inside the drawing frame.

5. A straight line drawing method according to claim 4, wherein when the midpoint is located outside the drawing frame, when both of the first point and the midpoint are located on the opposite side of the drawing frame with respect to at least any one of the plurality of the frame defining lines, and when both of the second point and the midpoint are located on the opposite side of the drawing frame with respect to at least any one of the plurality of the frame defining lines, it is determined that the third point does not exist.

6. A straight line drawing method according to claim 4, wherein when the midpoint is located outside the drawing frame, and when at least one of the first point and the midpoint is located on the drawing frame side with respect to any of the plurality of the frame defining lines, a portion between the second point and the midpoint is removed from a drawing target of the drawing target straight line, and the first point and the midpoint are established as two end points of a new drawing target straight line.

7. A straight line drawing method according to claim 4, wherein coordinate data of the midpoint is determined by addition of coordinate data of the first and the second points and by right shift operation.

8. A straight line drawing program allowing a computer to execute the procedures of:
determining a third point which is on a drawing target straight line inside a drawing frame, when the drawing target straight line is drawn which has two end points as first and second points that are located outside the drawing frame defined by a plurality of frame defining lines, and in which at least one of the first and the second points is located on the drawing frame side with respect to any of the plurality of the frame defining lines; and
drawing the drawing target straight line inside the frame, when the third point exists.

9. A straight line drawing apparatus comprising:
an arithmetic circuit which determines a third point which is on a drawing target straight line inside a drawing frame, when the drawing target straight line is drawn which has two end points as first and second points that are located outside the drawing frame defined by a plurality of frame defining lines, and in which at least one of the first and the second points is located on the drawing frame side with respect to any of the plurality of the frame defining lines; and
a straight line drawing circuit which draws the drawing target straight line inside the frame, when the third point exists.

10. A straight line drawing apparatus according to claim 9, wherein the arithmetic circuit determines a midpoint between the first and the second points on the drawing target straight line, and establishes the midpoint as the third point when the midpoint is located inside the drawing frame.

11. A straight line drawing apparatus according to claim 10, wherein the arithmetic circuit has an adder which adds coordinate data of the first and the second points, and a shift computing unit which conducts right shift operation for the added coordinate data.
